(19) United States
(12) Patent Application Publication
(10) Pub. No.: US 2025/0076891 A1
(43) Pub. Date: Mar. 6, 2025

(54) MOBILE DEVICE, SPEED CONTROL METHOD AND APPARATUS THEREOF, AND STORAGE MEDIUM

(71) Applicant: BEIJING XIAOMI ROBOT TECHNOLOGY CO., LTD., Beijing (CN)

(72) Inventor: Dongfang LI, Beijing (CN)

(73) Assignee: BEIJING XIAOMI ROBOT TECHNOLOGY CO., LTD., Beijing (CN)

(21) Appl. No.: 18/287,291

(22) PCT Filed: May 23, 2022
(86) PCT No.: PCT/CN2022/094525

§ 371 Date: Oct. 17, 2023

(51) Int. Cl. G05D 1/644; G05D 1/246; G05D 1/622; G05D 1/65

(52) U.S. Cl. CPC G05D 1/644; G05D 1/246; G05D 1/622; G05D 1/65

(57) ABSTRACT

A speed control method, including: obtaining a cost map of a moving area and a target path of the mobile device moving in the moving area; based on the cost map, determining a current target distance between the mobile device and an obstacle, and a current turning curvature; determining a target speed of the mobile device based on the current target distance, the current turning curvature, and a maximum limiting speed of the mobile device; and controlling the mobile device to move at the target speed.

### CROSS REFERENCE TO RELATED APPLICATIONS

This application is a U.S. national phase application of International Application No. PCT/CN2022/094525, filed on May 23, 2022, the disclosure of which is incorporated herein by reference in its entirety for all purposes.

### BACKGROUND

At present, autonomous mobile devices are widely used in various industrial and life scenes, such as logistics robots, food delivery robots, and sweeping robots. The motion control planning of mobile devices directly determines the operation effect and safety level of the mobile devices. In related technologies, the moving speed control effect of mobile devices is poor, resulting in lower safety and moving efficiency of the mobile devices.

### SUMMARY

The present disclosure relates to the technical field of intelligent robots, and in particular to specifically to a mobile device, a speed control method thereof, and a storage medium.

In a first aspect, an embodiment of the present disclosure provides a speed control method applied to a mobile device, and the method includes:
obtaining a cost map of a moving area and a target path of the mobile device moving in the moving area;
based on the cost map, determining a current target distance between the mobile device and an obstacle, and a current turning curvature of the mobile device when moving along the target path;
determining a target speed of the mobile device based on the current target distance, the current turning curvature, and a maximum limiting speed of the mobile device; and
controlling the mobile device to move at the target speed.

In a second aspect, an embodiment of the present disclosure provides a mobile device, including:
a processor; and
a memory storing computer instructions for causing the processor to perform the method according to any embodiment in the first aspect.

In a third aspect, an embodiment of the present disclosure provides a storage medium, which stores computer instructions for causing a computer to perform the method according to any embodiment in the first aspect.

### BRIEF DESCRIPTION OF THE DRAWINGS

In order to explain the technical solutions more clearly in specific embodiments of the present disclosure or the prior art, accompanying drawings required for the description of the specific embodiments or the prior art will be briefly introduced below. It is obvious that the drawings in the following description are some embodiments of the present disclosure. For those of ordinary skill in the art, other drawings can also be obtained based on these drawings, without paying any creative labor.

FIG. 1 is a structural block diagram of a mobile device according to some embodiments of the present disclosure.

FIG. 2 is a flowchart of a speed control method according to some embodiments of the present disclosure.

FIG. 3 is a flowchart of a speed control method according to some embodiments of the present disclosure.

FIG. 4 is a schematic diagram of a speed control method according to some embodiments of the present disclosure.

FIG. 5 is a flowchart of a speed control method according to some embodiments of the present disclosure.

FIG. 6 is a flowchart of a speed control method according to some embodiments of the present disclosure.

FIG. 7 is a schematic diagram of a speed control method according to some embodiments of the present disclosure.

FIG. 8 is a flowchart of a speed control method according to some embodiments of the present disclosure.

FIG. 9 is a flowchart of a speed control method according to some embodiments of the present disclosure.

FIG. 10 is a structural block diagram of a speed control apparatus according to some embodiments of the present disclosure.

### DETAILED DESCRIPTION OF THE EMBODIMENTS

The technical solutions in the embodiments of the present disclosure will be described clearly and completely below in combination with the accompanying drawings. Obviously, the described embodiments are only part of the embodiments of the present disclosure, not all of them. Based on the embodiments in the disclosure, all other embodiments obtained by those of ordinary skill in the art without doing creative work belong to the protection scope of the present disclosure. In addition, technical features involved in different embodiments of the present disclosure described below can be combined with each other as long as they do not conflict with each other.

At present, mobile devices such as sweeping robots, logistics robots, food delivery robots, and foot robots can move autonomously in preset operation spaces to achieve corresponding operation requirements. The speed control of mobile devices is an important part of motion planning. If the mobile devices move too fast, the risk of an accident and losses caused by the accident will increase. If the mobile devices move too slowly, their operation efficiency will also decreases.

In related technologies, in some scenes, a working area of a mobile device can be divided in advance to perform speed limiting. For example, the whole moving area of the mobile device can be divided into three zones A, B and C in advance. Different maximum limiting speeds are set in advance for each zone according to obstacles, mobile device density and other factors, so that when the mobile device runs to a certain zone, the mobile device will operate according to a maximum limiting speed specified for the zone.

In this scenario, the mobile device cannot adaptively adjust the moving speed based on changes of obstacles, and can only operate according to the speed limited for the zone. When the density of obstacles or devices in a certain zone with a low limiting speed decreases, the mobile device still operates according to the low limiting speed, resulting in a decrease in the operation efficiency of the mobile device. On the contrary, when the density of obstacles or devices in a certain zone with a high limiting speed increases, the mobile device still operates according to the high limiting speed, resulting in a significant increase in the risk of collision, scratch, and other accidents on the mobile device. In addition, the mobile device can only achieve the control of the moving speed in the set zones, and cannot achieve speed adaptive control for other moving areas, so the adaptability of the mobile device is very poor.

Based on the defects in the aforementioned related technologies, the present disclosure provides a mobile device, a speed control method and apparatus thereof, and a storage medium, aiming at achieving speed adaptive control of the mobile device, reducing the risk of an accident of the mobile device, and improving the safety and moving efficiency of the mobile device.

In a first aspect, an embodiment of the present disclosure provides a speed control method, which can be applied to a mobile device. The mobile device in the embodiment of the present disclosure can be any type of device with autonomous motion capability suitable for implementation, such as a foot robot, a sweeping robot, a logistics robot, a food delivery robot, an intelligent mobile trash can, which in not limited in the present disclosure.

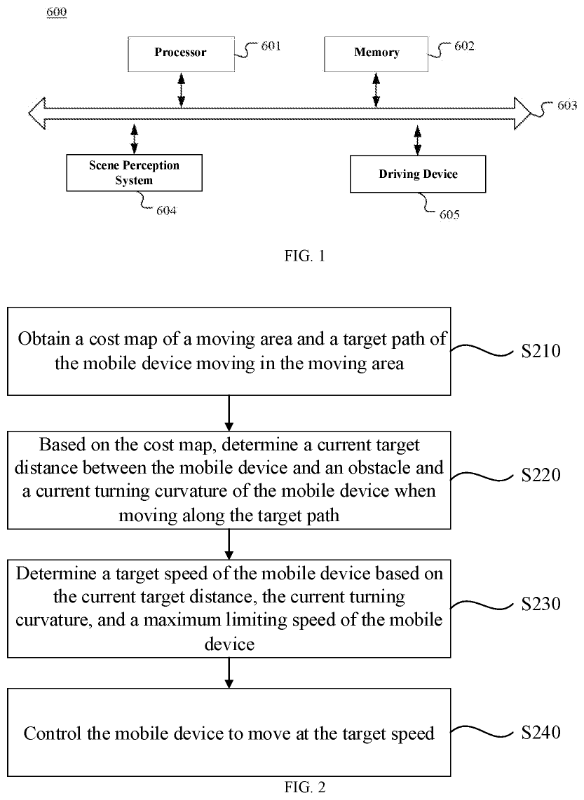

As shown in FIG. 1, in some embodiments, a mobile device 600, as an example in the present disclosure, includes a processor 601, a memory 602, a scene perception system 604, and a driving device 605.

The processor 601, the memory 602, the scene perception system 604, and the driving device 605 establish a communicable connection between any two of them through a bus 603.

The processor 601 can be any type of processor with one or more processing cores. The processor 601 can perform single-threaded or multi-threaded operations for parsing instructions to perform operations such as obtaining data, performing logical operation functions, and issuing operation processing results.

The memory 602 may include a non-volatile computer readable storage medium, such as at least one disk storage device, flash memory device, distributed storage device remotely set relative to the processor 601, or other non-volatile solid-state storage device. The memory can have a program storage area for storing non-volatile software programs, non-volatile computer executable programs and modules, which can be called by the processor 601 to cause the processor 601 to perform one or more method steps. The memory 602 may also include a volatile random storage medium, or a storage portion such as a hard disk, as a data storage area for storing operation processing results and data output by the processor 601.

The scene perception system 604 is a sensor system used by the mobile device to obtain data of a current scene. Relevant data of the current scene is collected by the scene perception system 604, so that the mobile device can realize device localization, map construction, and other functions.

In some implementations, the scene perception system 604 may be a simultaneous localization and mapping (SLAM) system. The SLAM system can include a plurality of sensors, such as a monocular camera, a binocular camera, a lidar, an inertial measurement unit (IMU) sensor, a time of flight (ToF) sensor. Through these sensors, the data of the mobile device in the process of movement are collected in real time, and based on the collected data, the device localization and mapping are realized by SLAM algorithm.

In the embodiment of the present disclosure, a cost map during the movement of the mobile device can be established through the data collected by the scene perception system 604, so as to realize path planning and speed control of the mobile device, which will be described in detail in the following methods of the present disclosure, and will not be elaborated herein.

The driving device 605 is a power system of the mobile device, which is used to drive the mobile device 600 to generate displacement. In some embodiments, the driving device 605 may include mechanical structures such as motors, transmission mechanisms, and rollers, which can be undoubtedly understood and fully implemented by those skilled in the art, and will not be described in detail in the present disclosure. Those skilled in the art can understand that mobile device 600 can also include various other electrical components and mechanical components, which will not be described in detail in the present disclosure.

On the basis of the mobile device shown in FIG. 1, an embodiment of the present disclosure provides a speed control method for real-time control of the speed of the mobile device 600 during movement. This method can be performed by the processor 601 of the mobile device 600, and will be described below in combination with the embodiment in FIG. 2.

As shown in FIG. 2, in some embodiments, the speed control method in an example of the present disclosure includes steps S210 to S240.

In S210, a cost map of a moving area and a target path of the mobile device moving in the moving area are obtained.

It can be understood that the cost map is a virtual map calculated based on an environment map and data collected by sensors of the mobile device, indicating the cost that the mobile device will consume when moving in a specific way. The path planning problem for the mobile device is defined as finding a path with the least cost on the cost map.

The moving area refers to an area with a preset range that allows the mobile device to move autonomously. For example, a sweeping robot is taken as an example of the mobile device, the moving area is a working area of the sweeping robot.

In the embodiment of the present disclosure, scene data of the mobile device during movement can be collected in real time based on the scene perception system 604 of the mobile device. The scene data can include image data in front of the mobile device, lidar data, position-orientation data of the motion of the mobile device itself, speed data, etc. Based on the collected scene data, a cost map of the area in front of the mobile device during movement and a target path of the mobile device in a next period of time can be obtained.

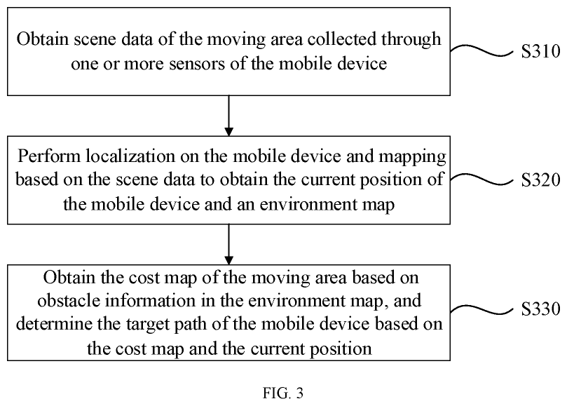

The process of calculating the cost map and the target path of the mobile device will be explained in the embodiment shown in FIG. 3 below, and will not be expanded herein.

In S220, based on the cost map, a current target distance between the mobile device and an obstacle and a current turning curvature of the mobile device when moving along the target path are determined.

In the embodiment of the present disclosure, the current target distance refers to a distance between a current position of the mobile device and the front obstacle, and the current turning curvature refers to a turning curvature of the mobile device when moving along the target path currently.

In traditional robot path planning solution, generally, only the distance between the mobile device and the front obstacle is concerned. When the distance between the mobile device and the obstacle is relatively close, in order to reduce the risk of collision or scratch between the mobile device and the obstacle, the moving speed of the robot is reduced.

However, the inventor of the present disclosure found that whether a mobile device will have an accident depends on two aspects. On the one hand, it depends on the distance between the mobile device and the obstacle, and the closer the distance between the two, the higher the risk of an accident. On the other hand, it also depends on a turning angle of the mobile device. During the turning process, the mobile device often encounters collisions and scratches due to a blind area of vision. The larger the turning angle of the mobile device, the greater the risk of an accident.

In the embodiment of the present disclosure, based on the cost map, it is not only necessary to determine the target distance between the current position of the mobile device and the front obstacle, but also to determine the turning curvature of the mobile device when moving along the target path currently. The turning curvature can reflect the magnitude of the turning angle. When the target path is a straight line and the mobile device is currently moving along the straight line, the corresponding turning curvature is zero.

In some embodiments, it can be determined whether there are is an obstacle within a preset range in front of the current position of the mobile device based on the cost map, and the preset range represents a preset forward-looking range of the robot. If there is an obstacle within the preset range, the distance between the obstacle and the current position of the mobile device can be determined based on the cost map, i.e., the current target distance as described in the embodiment of the present disclosure.

In some embodiments, the current target distance between the mobile device and the obstacle includes two mutually perpendicular components, namely a first distance and a second distance.

The first distance refers to a distance component of the obstacle perpendicular to the target path. Due to a certain volume width of the mobile device itself, when the mobile device moves along the target path, if the distance component of the front obstacle perpendicular to the target path is small, the risk of collision or scratch between the mobile device and the obstacle is high.

The second distance refers to a distance component of the obstacle in a direction parallel to the target path. When the mobile device moves along the target path, if the distance component of the front obstacle parallel to the target path is small, it indicates that the current position of the mobile device is close to the obstacle, and the risk of collision or scratch is high.

In the following embodiments of the present disclosure, the specific principles and processes of the first distance and the second distance will be explained, and will not be elaborated herein.

In addition, it can be understood that, in the embodiment of the present disclosure, a line connecting between the current position of the mobile device and the position of the obstacle can also be directly used as the current target distance, that is, it is not necessary to calculate the first and second distance components mentioned above, which is not limited in the present disclosure.

In some embodiments, based on the cost map, within a preset range in front of the mobile device, two normal line segments spaced by a preset distance made for the target path can be used as reference line segments, namely a first reference line segment and a second reference line segment.

It can be understood that, since the first reference line segment and the second reference line segment are always perpendicular to the target path, when the target path is a straight line, the first reference line segment and the second reference line segment are in a parallel positional relationship and will not intersect.

When the target path is a curve, the first reference line segment and the second reference line segment are no longer parallel to each other, and as the curvature of the target path increases, the first reference line segment and the second reference line segment will intersect and form an angle. The larger the curvature of the target path, the greater the value of the angle. Thus, the turning curvature of the mobile device when moving along the target path currently can be determined by the value of the angle.

The specific process and principle of determining the turning curvature will be explained in detail in the following embodiments of the present disclosure, and will not be elaborated herein.

In addition, it can be understood that the turning curvature indicates the degree of turning that the mobile device is currently moving along the target path. In the embodiment of the present disclosure, it is not limited to using the above manner to determine the turning curvature, and any other manner suitable for implementation can be used, as long as the turning curvature parameter representing a bending degree of the target path can be obtained. For example, based on the cost map, the curvature of the target path within a preset range in front of the mobile device can be directly calculated to obtain the turning curvature of the target path, which is not limited in the present disclosure.

In S230, a target speed of the mobile device is determined based on the current target distance, the current turning curvature, and a maximum limiting speed of the mobile device.

The maximum limiting speed Vₘₐₓ of the mobile device represents a maximum operating speed allowed for the mobile device. The speed control task of the mobile device can be understood as a process of adjusting the maximum limiting speed of the mobile device. By adaptively adjusting the maximum limiting speed of the mobile device, the mobile device can maintain an appropriate moving speed under different road conditions.

In the embodiment of the present disclosure, after obtaining the target distance between the current position of the mobile device and the front obstacle, and the turning curvature of the mobile device when moving along the target path currently, the maximum limiting speed Vₘₐₓ of the mobile device can be comprehensively adjusted based on the target distance and the turning curvature to obtain the corresponding target speed.

It can be understood that the target distance reflects the proximity between the mobile device and the obstacle. The smaller the target distance, the higher the risk of an accident for the mobile device, and thus the lower the target speed should be. The turning curvature reflects a bending degree of the movement path of the mobile device itself. The greater the turning curvature, the higher the risk of an accident for the mobile device, and thus the lower the target speed should be.

Based on the above principles, the maximum limiting speed of the mobile device can be comprehensively adjusted based on the current target distance and the current turning curvature to obtain the target speed of the mobile device for movement.

For example, in some embodiments, a straight-line travelling speed component of the mobile device can be determined based on the current target distance and the maximum limiting speed, and a turning speed component of the mobile device can be determined based on the current turning curvature and the maximum limiting speed. Then, the straight-line travelling speed component and the turning speed component are weighted and summed to obtain the final target speed. This will be explained in the following implementations of the present disclosure and will not be elaborated herein.

In S240, the mobile device is controlled to move at the target speed.

In the embodiment of the present disclosure, after determining the target speed of the mobile device, the mobile device can be controlled to move at that target speed. For example, as shown in FIG. 1, the processor 601 can generate corresponding control instructions based on the target speed and send the control instructions to the driving device 605. The driving device 605 outputs a motor torque according to the control instructions, thereby controlling the mobile device to move at the target speed.

The speed control process of the mobile device for one control cycle is illustrated as an example. The above method process can be repeated for each control cycle, and the speed control of the mobile device in the process of autonomous movement can be realized. For example, in an example, the control frequency of the mobile device is 5 Hz, that is, the above method process is performed once every 200 ms to achieve the speed control of the mobile device.

From the above description, it can be seen that in the embodiment of the present disclosure, the current moving speed is controlled by the current target distance between the mobile device and the obstacle, and the current turning curvature, so that the moving speed can be adjusted adaptively according to the current road condition, and the risk of an accident can be reduced. Moreover, in speed control, not only the target distance between the mobile device and the obstacle, but also the bending degree of the target path of the mobile device itself are considered, and thus the risk of an accident caused by a blind area of vision at turns can be reduced, and speed control effect can be further improved.

As shown in FIG. 3, in the speed control method in an example of the present disclosure, obtaining the cost map of the moving area and the target path includes steps S310 to S330.

In S310, scene data of the moving area collected through one or more sensors of the mobile device is obtained.

In the embodiment of the present disclosure, as shown in FIG. 1, during the movement of the mobile device 600, the scene perception system 604 can collect the scene data in a current state.

For example, in an example, the scene perception system 604 is a VSLAM system based on computer vision. The scene data collected by the VSLAM system can include scene image data of the moving area in front of the mobile device, physical depth data, and motion information of the mobile device itself.

In other examples, the scene perception system 604 can also be other systems, such as lidar, which is not limited in the present disclosure.

In S320, localization on the mobile device and mapping are performed based on the scene data to obtain the current position of the mobile device and an environment map.

In the embodiment of the present disclosure, based on the scene data collected by the scene perception system 604, according to the scene data, including, for example, image data, physical depth data, lidar data, IMU data, etc., an simultaneous localization and mapping (SLAM) algorithm can be used to locate the mobile device and reconstruct an map of the moving area in front of the mobile device, so as to obtain the current position of the mobile device and the environment map of the moving area.

The principle and process of the SLAM algorithm can be undoubtedly understood and fully implemented by those skilled in the art by referring to relevant technologies, and is not limited in the present disclosure.

In S330, the cost map of the moving area is obtained based on obstacle information in the environment map, and the target path of the mobile device is determined based on the cost map and the current position.

Based on the above, the cost map is a virtual map used for path planning of the mobile device. In some implementations, the cost map can be a local 2D cost map within a preset range in front of the mobile device.

In an embodiment of the present disclosure, after obtaining the environment map, the obstacle information in the environment map can be determined by combining data such as lidar data or physical depth data, and then the corresponding cost map can be obtained based on the obstacle information and the environment map.

However, after obtaining the cost map, the target path of the mobile device within the cost map can be determined based on the current position of the mobile device and a preset global path of the mobile device. The target path is a planned moving path of the mobile device in a next period of time.

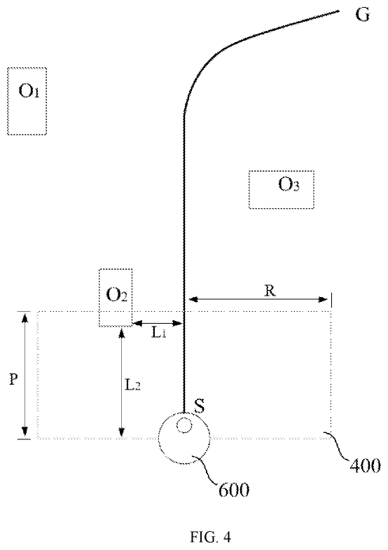

For example, in an example, the cost map can be shown in FIG. 4, the current position of mobile device 600 is S, a target position is G, and a curve SG is a target path. There are three obstacles in the moving area, namely obstacle O₁, obstacle O₂, and obstacle O₃.

In the following embodiments of the present disclosure, the speed control method in the present disclosure will be explained using the cost map shown in FIG. 4. However, it can be understood that FIG. 4 is only an example of the embodiments in the present disclosure and does not limit the present disclosure.

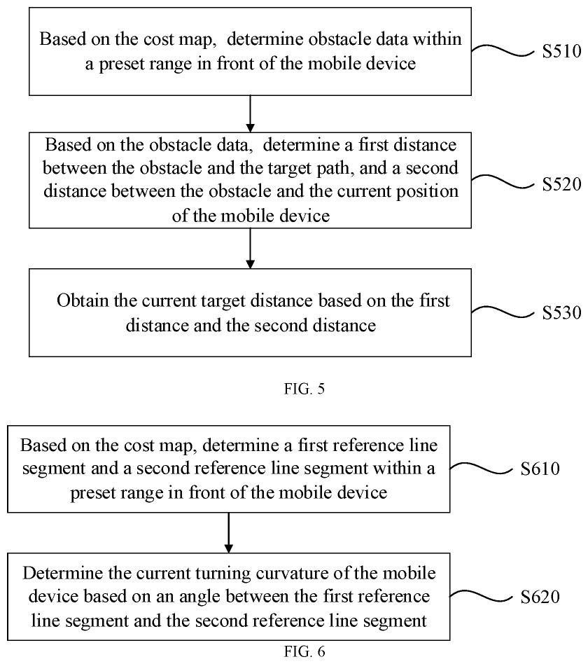

As shown in FIG. 5, in the speed control method in an example of the present disclosure, determining the current target distance between the mobile device and the obstacle includes steps S510 to S530.

In S510, based on the cost map, obstacle data within a preset range in front of the mobile device is determined.

In S520, based on the obstacle data, a first distance between the obstacle and the target path, and a second distance between the obstacle and the current position of the mobile device are determined.

In S530, the current target distance based on the first distance and the second distance is obtained.

In the embodiment of the present disclosure, the preset range in front of the mobile device refers to an area with a preset forward-looking range in front of the moving direction of the mobile device.

It can be understood that in the movement process of the mobile device, it is necessary to determine information on the road condition in front of the mobile device in advance, so as to control the speed of the mobile device. That is, the speed control and path planning of the mobile device should be forward-looking. The preset range described in the present disclosure refers to an area with a preset forward-looking range of the mobile device.

For example, in the example in FIG. 4, a preset range 400 in front of the mobile device 600 is an area with a rectangular range shown by the dashed line in the figure. As the mobile device 600 moves, the preset range 400 is always located in front of the moving direction of the mobile device 600. In an example the present disclosure, the size of the preset range is 2R*P, where specific values of R and P can be set according to factors such as the size of the mobile device and requirements of the scene, which is not limited in the present disclosure.

Those skilled in the art can understand that the preset range 400 in FIG. 4 is only an example of the embodiment of the present disclosure. The preset range 400 is not limited to the area with the rectangular range shown in FIG. 4, but can also be, for example, an area with a sector range, etc., which is not limited in the present disclosure.

In the embodiment of the present disclosure, after obtaining the cost map of the moving area, it can be determined whether there is an obstacle within a preset range in front of the current position of the mobile device based on the cost map. If there is an obstacle within the preset range, the obstacle data can be determined based on the cost map. The obstacle data includes position coordinates of the obstacle in an image coordinate system.

In the embodiment of the present disclosure, the current target distance between the mobile device and the obstacle includes two mutually perpendicular components, namely a first distance and a second distance. The first distance refers to a distance that the obstacle is perpendicular to the target path, and the second distance refers to a distance between the obstacle and the mobile device in a direction parallel to the target path.

For example, in the example of FIG. 4, an obstacle O₂ is located within the preset range 400, so based on obstacle data, a first distance L₁ between the obstacle and the target path, and a second distance L₂ between the obstacle and the mobile device, can be determined on the cost map.

In this example, the first distance refers to the shortest distance L₁ obtained by making the obstacle O₂ perpendicular to the target path SG. The second distance refers to the shortest distance L₂ between the obstacle O₂ and the mobile device 600 in the direction parallel to the target path. That is, the first distance L₁ and the second distance L₂ are perpendicular to each other.

In the embodiment of the present disclosure, the current target distance between the mobile device and the obstacle includes the first distance L₁ and the second distance L₂ mentioned above. Therefore, after obtaining the first distance L₁ and the second distance L₂, the first distance L₁ and the second distance L₂ are determined as the current target distance between the mobile device and the obstacle.

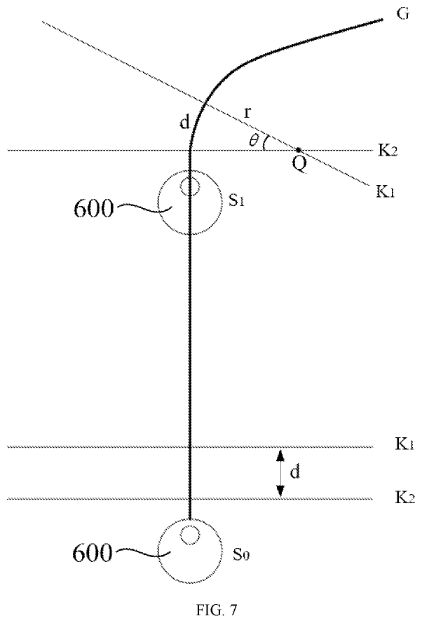

The process of determining the current target distance between the mobile device and the obstacle in the method of the present disclosure is explained above with reference to the embodiment in FIG. 5. The process of determining the current turning curvature in the method of the present disclosure will be described below with reference to FIGS. 6 and 7.

As shown in FIG. 6, in the speed control method in an example of the present disclosure, determining the current turning curvature of the mobile device when moving along the target path includes steps S610 and S620.

In S610, based on the cost map, a first reference line segment and a second reference line segment within a preset range in front of the mobile device are determined.

In S620, the current turning curvature of the mobile device is determined based on an angle between the first reference line segment and the second reference line segment.

In the embodiment of the present disclosure, based on the cost map, within a preset range in front of the mobile device, two normal line segments spaced by a preset distance made for the target path can be used as reference line segments, respectively defined as the first reference line segment and the second reference line segment. Referring to the cost map shown in FIG. 7, the obstacles O₁ to O₃ in the cost map are hidden for sake of clarity.

As shown in FIG. 7, within the preset range 400 in front of mobile device 600, two normal segments are made for the target path, namely a first reference line segment K₁ and a second reference line segment K₂. The first reference line segment K₁ and the second reference line segment K₂ are spaced by a preset distance d. It can be understood that the length of the first reference line segment K₁ and the second reference line segment K₂ can be set according to specific scene requirements, which is not limited in the present disclosure.

Continuing to refer to FIG. 7, it is assumed that when the current position of the mobile device 600 is S0, the target path is a straight line. Since the first reference line segment K₁ and the second reference line segment K₂ are both perpendicular to the target path, the first reference line segment K₁ and the second reference line segment K₂ are parallel to each other, and they will not intersect, and there will be no angle.

It is assumed that when the current position of mobile device 600 is S1, the target path ahead is a curve. Since the first reference line segment K₁ and the second reference line segment K₂ are always perpendicular to the target path, the first reference line segment K₁ and the second reference line segment K₂ will intersect, with an intersection point of Q and an angle θ between the two.

In addition, it is noted that since both the first reference line segment K₁ and the second reference line segment K₂ are line segments, that is, they are not infinitely extended, even if the first reference line segment K₁ and the second reference line segment K₂ are no longer parallel due to the bending of the target path, the first reference line segment K₁ and the second reference line segment K₂ will not intersect when the curvature is very small. By changing the preset distance d between the first reference line segment K₁ and the second reference line segment K₂, and the length of the line segments, a curvature boundary of the target path when ends of the first reference line segment K₁ and the second reference line segment K₂ intersect can be adjusted, which can be understood and fully implemented by those skilled in the art, and will not be further elaborated in the present disclosure.

Based on FIG. 7, it can be seen that in the embodiment of the present disclosure, when the first reference line segment and the second reference line segment do not intersect, it indicates that the target path within the preset range is a straight line or has a small curvature. At this time, there is no angle between the first reference line segment and the second reference line segment, and the current turning curvature of the target path is defined as zero.

When the first reference line segment intersects with the second reference line segment, based on the coordinate data of the cost map, position coordinates of an intersection point Q of the first reference line segment K₁ and the second reference line segment K₂ can be determined. After obtaining the position coordinates of the intersection point Q, a distance r from the intersection point Q to the target path can be determined, and an arc d is a known preset distance. Therefore, the value of the angle θ between the first reference line segment K₁ and the second reference line segment K₂ can be determined using a sector formula, which is represented as θ=d/r. In the embodiment of the present disclosure, the value of the angle θ can be determined as the current turning curvature of the mobile device.

Based on the above process, the target distance between the current position of the mobile device and the obstacle, and the turning curvature can be determined, and then the maximum limiting speed of the mobile device can be adjusted based on the target distance and the turning curvature, which will be described in detail below.

As shown in FIG. 8, in the speed control method in an example of the present disclosure, determining the target speed of the mobile device based on the current target distance, the current turning curvature, and the maximum limiting speed includes steps S810 to S830.

In S810, a straight-line travelling speed component of the mobile device is determined based on the current target distance and the maximum limiting speed.

In the embodiment of the present disclosure, after obtaining the current target distance between the mobile device and the obstacle, the maximum limiting speed can be adaptively adjusted based on the size of the current target distance to obtain the straight-line travelling speed component.

Specifically, the current target distance is positively correlated with the straight-line travelling speed component. That is, the greater the current target distance, it means that the farther the mobile device is currently from the obstacle, the lower the risk of an accident, and thus the greater the straight-line travelling speed component. On the contrary, the smaller the current target distance, it means that the closer the mobile device is currently from the obstacle, the higher the risk of an accident, and thus the smaller the straight-line travelling speed component.

Based on the above principle, those skilled in the art can undoubtedly achieve the calculation of the straight-line travelling speed component, and the calculation method is not limited in the present disclosure. For example, in some embodiments, a corresponding relationship between the current target distance and the straight-line travelling speed component can be established in advance, and the size of the straight-line travelling speed component can be determined by looking up the corresponding relationship.

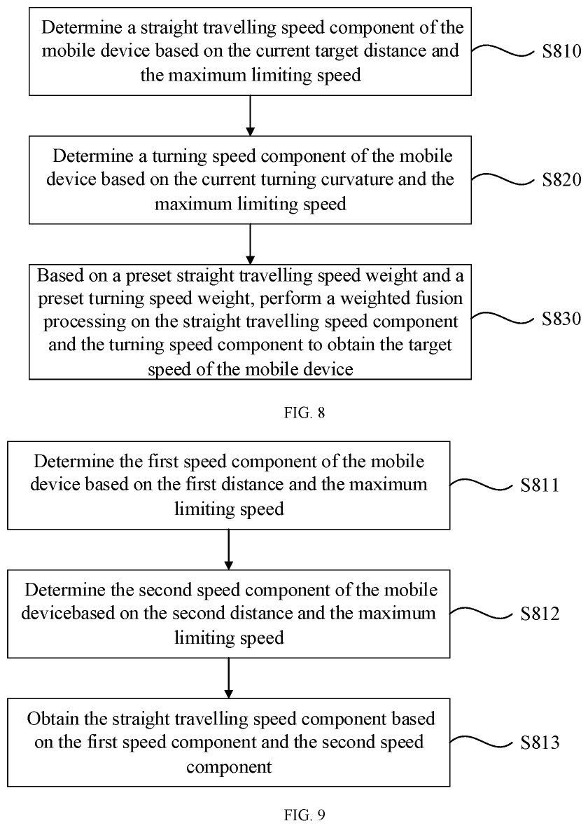

In some embodiments of the present disclosure, as described in FIG. 5 above, the current target distance includes the first distance L₁ and the second distance L₂. Therefore, the straight-line travelling speed component in an embodiment of the present disclosure also includes a first speed component and a second speed component, which will be described with reference to the embodiment in FIG. 9.

As shown in FIG. 9, in the speed control method in an example of the present disclosure, determining the straight-line travelling speed component of the mobile device based on the current target distance and the maximum limiting speed includes steps S811 to S813.

In S811, the first speed component of the mobile device is determined based on the first distance and the maximum limiting speed.

In S812, the second speed component of the mobile device is determined based on the second distance and the maximum limiting speed.

In S813, the straight-line travelling speed component is obtained based on the first speed component and the second speed component.

As shown in FIG. 4, the first distance L₁ between the mobile device 600 and the obstacle O₂, and the second distance L₂ between the mobile device 600 and the obstacle O₂, can be obtained through the aforementioned implementation manner. Thus, the first speed component and the second speed component can be expressed as:

$${V}_{1} = \frac{{L}_{1}}{R} * {V}_{max} \qquad ( 1 )$$

$${V}_{2} = \frac{{L}_{2}}{P} * {V}_{max} \qquad ( 2 )$$

In the above formulas (1) and (2), V₁ represents the first speed component, V₂ represents the second speed component, L₁ represents the first distance, L₂ represents the second distance, R represents half the width of the preset range, P represents the length of the preset range, and Vₘₐₓ represents the maximum limiting speed of the mobile device.

As shown in FIG. 4, when there is no obstacle within the preset range, the first distance L₁=R and the second distance L₂=P can be set, in this case, the first speed component V₁=Vₘₐₓ, and the second speed component V₂=Vₘₐₓ.

Based on the above formulas (1) and (2), the first speed component V₁ and the second speed component V₂ of the mobile device can be calculated, and then the first speed component V₁ and the second speed component V₂ are determined as the straight-line travelling speed component.

In S820, a turning speed component of the mobile device is determined based on the current turning curvature and the maximum limiting speed.

In the embodiment of the present disclosure, after obtaining the turning curvature of the current target path of the mobile device, the maximum limiting speed can be adaptively adjusted based on the size of the turning curvature to obtain the turning speed component.

Specifically, the turning curvature is negatively correlated with the turning speed component. That is, the larger the current turning curvature, it means that the higher the risk that the mobile device will have an accident, so the turning speed component should be smaller. On the contrary, the smaller the current turning curvature, it means that the lower the risk that the mobile device will have an accident, and the greater the turning speed component.

Based on the above principle, in some embodiments, the calculation process of the turning speed component can be expressed as:

$${V}_{3} = ( 1 - \frac{2 θ}{π} ) * {V}_{max} \qquad ( 3 )$$

In the above formula (3), V₃ represents the turning speed component, θ represents the current turning curvature, and Vₘₐₓ represents the maximum limiting speed.

As shown in FIG. 7, when there is no intersection between the first reference line segment K₁ and the second reference line segment K₂, the current turning curvature θ can be set to zero, thus it can be seen from formula (3) that the turning speed component V₃ at this time, V₃=Vₘₐₓ.

In S830, based on a preset straight-line travelling speed weight and a preset turning speed weight, a weighted fusion processing is performed on the straight-line travelling speed component and the turning speed component to obtain the target speed of the mobile device.

It can be understood that the straight-line travelling speed component represents a straight-line travelling speed of the mobile device under the current road condition, and the turning speed component represents a turning speed of the mobile device under the current road condition. In the embodiment of the present disclosure, it is necessary to consider both the risk of a collision between the mobile device and the obstacle in the case of travelling straight, and the risk of an accident in the case of turning. Therefore, the weighted fusion processing can be performed on the straight-line travelling speed component and the turning speed component to obtain the final target speed.

In some embodiments, the straight-line travelling speed weight includes a first weight value a and a second weight value b, and the turning speed weight includes a third weight value c. Therefore, the target speed can be represented as:

$$V = a * {V}_{1} + b * {V}_{2} + c * {V}_{3} \qquad ( 4 )$$

In the above formula (4), V represents the target speed, V₁ represents the first speed component, a represents the first weight value of the first speed component, V₂ represents the second speed component, b represents the second weight value of the second speed component, V₃ represents the turning speed component, and c represents the third weight value of the turning speed component, where a+b+c=1.

Specific values of the first weight value a, the second weight value b, and the third weight value c can set by those skilled in the art according to requirements of specific scenarios, and are not limited in the present disclosure.

Through the above formula (4), the fusion processing can be performed on the first speed component, second speed component, and turning speed component to obtain the target speed corresponding to the mobile device.

Combining with the formulas (1) to (4), the control principle of the method in the embodiment of the present disclosure is explained in the following scenarios.

When the mobile device moves in a straight line or has a small turning curvature, and there is no obstacle within the preset range in front of the mobile device, the first speed component V₁, the second speed component V₂ and the turning speed component V₃ can be calculated based on the aforementioned formulas (1) to (3), i.e., V₁=Vₘₐₓ, V₂=Vₘₐₓ, and V₃=Vₘₐₓ. By substituting into the formula (4), the target speed V=Vₘₐₓ can be obtained, which means that the mobile device maintains operation at the maximum limiting speed.

When the mobile device moves in a straight line or has a small turning curvature, and there is an obstacle within the preset range in front of the mobile device, the turning speed component V₃ can be calculated based on the aforementioned formula (3), V₃=Vₘₐₓ. The first speed component V₁ and the second speed component V₂ are both less than Vₘₐₓ. The target speed V obtained by substituting into the formula (4) should also be less than Vₘₐₓ, which means that the speed of the mobile device should be reduced adaptively.

When the mobile device moves along a curve and there is no obstacle within the preset range in front of the mobile device, the first speed component V₁ and the second speed component V₂ can be calculated based on the aforementioned formulas (1) and (2), i.e., V₁=Vₘₐₓ, V₂=Vₘₐₓ, the turning speed component V₃ calculated based on the formula (3) is smaller than Vₘₐₓ. The target speed V obtained by substituting into the formula (4) should also be smaller than Vₘₐₓ, which means that the speed of the mobile device should be reduced adaptively.

When the mobile device moves along a curve and there is an obstacle within the preset range in front of the mobile device, the first speed component V₁, the second speed component V₂, and the turning speed component V₃ calculated based on the aforementioned formulas (1) to (3) are smaller than Vₘₐₓ. The target speed V obtained by substituting into the formula (4) should also be smaller than Vₘₐₓ, which means that the speed of the mobile device should be reduced adaptively.

Based on the above scenarios, it can be seen that in the embodiment of the present disclosure, the speed of the mobile device is not only adjusted based on the distance between the mobile device and the obstacle, but also adjusted in combination with the turning curvature. During the turning process, even if there is no obstacle in front of the mobile device, the speed of the mobile device will still be reduced, so as to avoid overturning caused by turning too fast, or reduce the risk of an accident caused by a blind area of vision at turns.

In some embodiments, to ensure the normal operation of the mobile device, a preset speed range of the mobile device can be set in advance, which can limit a minimum speed limit Vₘᵢₙ and a maximum limiting speed Vₘₐₓ of the mobile device, that is, the moving speed of the mobile device should be within a preset speed range [Vₘᵢₙ, Vₘₐₓ].

When the target speed obtained through the aforementioned method is less than the minimum speed limit Vₘᵢₙ, the mobile device can be controlled to move at the minimum speed limit Vₘᵢₙ. When the target speed is greater than the maximum limiting speed Vₘₐₓ, the mobile device can be controlled to move at the maximum limiting speed Vₘₐₓ. When the target speed is within the preset speed range [Vₘᵢₙ, Vₘₐₓ], the mobile device can be controlled to move at the target speed.

The specific value of the preset speed range [Vₘᵢₙ, Vₘₐₓ] can be set by those skilled in the art according to specific application scenarios, and are not limited in the present disclosure.

From the above description, it can be seen that in the embodiment of the present disclosure, the current moving speed is controlled by the current target distance between the mobile device and the obstacle, and the current turning curvature, so that the moving speed can be adaptively adjusted according to the current road condition, and the risk of an accident can be reduced. Moreover, in speed control, not only the target distance between the mobile device and the obstacle, but also the bending degree of the target path of the mobile device itself is considered, so as to avoid overturning caused by too fast turning speed, reduce the risk of an accident caused by a blind area of vision at turns, and further improve the speed control effect.

In a second aspect, an embodiment of the present disclosure provides a speed control apparatus, which can be applied to a mobile device. The mobile device in the embodiment of the present disclosure can be any type of device with autonomous motion capability suitable for implementation, such as a sweeping robot, a logistics robot, a food delivery robot, an intelligent mobile trash can, which in not limited in the present disclosure.

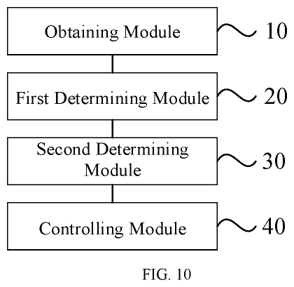

As shown in FIG. 10, the speed control apparatus in an example of the present disclosure includes:
an obtaining module 10, configured to obtain a cost map of a moving area and a target path of the mobile device moving in the moving area;
a first determining module 20, configured to determine, based on the cost map, a current target distance between the mobile device and an obstacle, and a current turning curvature of the mobile device when moving along the target path;
a second determining module 30, configured to determine a target speed of the mobile device based on the current target distance, the current turning curvature, and a maximum limiting speed of the mobile device; and
a controlling module 40, configured to control the mobile device to move at the target speed.

From the above description, it can be seen that in the embodiment of the present disclosure, the current moving speed is controlled by the current target distance between the mobile device and the obstacle, and the current turning curvature, so that the moving speed can be adaptively adjusted according to the current road condition, and the risk of an accident can be reduced. Moreover, in speed control, not only the target distance between the mobile device and the obstacle, but also the bending degree of the target path of the mobile device itself is considered, so as to reduce the risk of an accident caused by a blind area of vision at turns, and further improve the speed control effect.

In some embodiments, the obtaining module 10 is configured to:
obtain scene data of the moving area collected through one or more sensors of the mobile device;
perform localization on the mobile device and mapping based on the scene data to obtain a current position of the mobile device and an environment map; and
obtain the cost map of the moving area based on obstacle information in the environment map, and determine the target path of the mobile device based on the cost map and the current position.

In some embodiments, the first determining module 20 is configured to:
based on the cost map, determine obstacle data within a preset range in front of the mobile device;
based on the obstacle data, determine a first distance between the obstacle and the target path, and a second distance between the obstacle and a current position of the mobile device; where the first distance is perpendicular to the target path, and the second distance is parallel to the target path; and
obtain the current target distance based on the first distance and the second distance.

In some embodiments, the first determining module 20 is configured to:
based on the cost map, determine a first reference line segment and a second reference line segment within a preset range in front of the mobile device; where the first reference line segment and the second reference line segment are both perpendicular to the target path, and a preset distance is spaced between the first reference line segment and the second reference line segment; and
determine the current turning curvature of the mobile device based on an angle between the first reference line segment and the second reference line segment.

In some embodiments, the first determining module 20 is configured to:
in response to the first reference line segment intersecting with the second reference line segment, determine intersection coordinates of the first reference line segment and the second reference line segment based on the cost map, determine the angle between the first reference line segment and the second reference line segment based on the intersection coordinates and the preset distance, and determine the angle as the current turning curvature; or
in response to the first reference line segment not intersecting with the second reference line segment, determine that the current turning curvature is zero.

In some embodiments, the second determining module 30 is configured to:
determine a straight-line travelling speed component of the mobile device based on the current target distance and the maximum limiting speed; where the straight-line travelling speed component is positively correlated with the current target distance;
determine a turning speed component of the mobile device based on the current turning curvature and the maximum limiting speed; where the turning speed component is negatively correlated with the current turning curvature; and
based on a preset straight-line travelling speed weight and a preset turning speed weight, perform a weighted fusion processing on the straight-line travelling speed component and the turning speed component to obtain the target speed of the mobile device.

In some embodiments, the second determining module 30 is configured to:
determine a first speed component of the mobile device based on the first distance and the maximum limiting speed;
determine a second speed component of the mobile device based on the second distance and the maximum limiting speed; and
obtain the straight-line travelling speed component based on the first speed component and the second speed component.

In some embodiments, the controlling module 40 is configured to:
control the mobile device to move at the target speed in response to the target speed satisfying a preset speed range.

From the above description, it can be seen that in the embodiment of the present disclosure, the current moving speed is controlled by the current target distance between the mobile device and the obstacle, and the current turning curvature, so that the moving speed can be adaptively adjusted according to the current road condition, and the risk of an accident can be reduced. Moreover, in speed control, not only the target distance between the mobile device and the obstacle, but also the bending degree of the target path of the mobile device itself is considered, so as to avoid overturning caused by too fast turning speed, reduce the risk of an accident caused by a blind area of vision at turns, and further improve the speed control effect.

In a third aspect, an embodiment of the present disclosure provides a mobile device, including:
a processor; and
a memory storing computer instructions for causing the processor to perform the method according to any embodiment in the first aspect.

In a fourth aspect, an embodiment of the present disclosure provides a storage medium, which stores computer instructions for causing a computer to perform the method according to any embodiment in the first aspect.

From the above description, it can be seen that in the embodiment of the present disclosure, the current moving speed is controlled by the current target distance between the mobile device and the obstacle, and the current turning curvature, so that the moving speed can be adaptively adjusted according to the current road condition, and the risk of an accident can be reduced. Moreover, in speed control, not only the target distance between the mobile device and the obstacle, but also the bending degree of the target path of the mobile device itself is considered, so as to avoid overturning caused by too fast turning speed, reduce the risk of an accident caused by a blind area of vision at turns, and further improve the speed control effect.

Obviously, the above embodiments are only examples for clear explanation, rather than a limitation of implementation manners. For those skilled in the art, other changes or modifications in different forms can be made on the basis of the above description. It is not necessary and impossible to exhaust all the embodiments herein. However, the obvious changes or modifications arising from this are still within the protection scope of the present disclosure.

1. A speed control method, performed by a mobile device, comprising:
obtaining a cost map of a moving area and a target path of the mobile device moving in the moving area;
based on the cost map, determining a current target distance between the mobile device and an obstacle, and a current turning curvature of the mobile device in response to determining that the mobile device moving along the target path;
determining a target speed of the mobile device based on the current target distance, the current turning curvature, and a maximum limiting speed of the mobile device; and
controlling the mobile device to move at the target speed.

2. The method according to claim 1, wherein the obtaining the cost map of the moving area and the target path of the mobile device moving in the moving area comprises:
obtaining scene data of the moving area collected through one or more sensors of the mobile device;
performing localization on the mobile device and mapping based on the scene data to obtain a current position of the mobile device and an environment map; and
obtaining the cost map of the moving area based on obstacle information in the environment map, and determining the target path of the mobile device based on the cost map and the current position.

3. The method according to claim 1, wherein based on the cost map, determining the current target distance between the mobile device and the obstacle comprises:
based on the cost map, determining obstacle data within a preset range in front of the mobile device;
based on the obstacle data, determining a first distance between the obstacle and the target path, and a second distance between the obstacle and a current position of the mobile device, wherein the first distance is perpendicular to the target path, and the second distance is parallel to the target path; and
obtaining the current target distance based on the first distance and the second distance.

4. The method according to claim 1, wherein based on the cost map, determining the current turning curvature of the mobile device when moving along the target path comprises:
based on the cost map, determining a first reference line segment and a second reference line segment within a preset range in front of the mobile device, wherein the first reference line segment and the second reference line segment are both perpendicular to the target path, and a preset distance is spaced between the first reference line segment and the second reference line segment; and
determining the current turning curvature of the mobile device based on an angle between the first reference line segment and the second reference line segment.

5. The method according to claim 4, wherein the determining the current turning curvature of the mobile device based on the angle between the first reference line segment and the second reference line segment comprises:
in response to the first reference line segment intersecting with the second reference line segment, determining intersection coordinates of the first reference line segment and the second reference line segment based on the cost map, determining the angle between the first reference line segment and the second reference line segment based on the intersection coordinates and the preset distance, and determining the angle as the current turning curvature; or
in response to the first reference line segment not intersecting with the second reference line segment, determining that the current turning curvature is zero.

6. The method according to claim 1, wherein the determining the target speed of the mobile device based on the current target distance, the current turning curvature, and the maximum limiting speed of the mobile device comprises:
determining a straight-line travelling speed component of the mobile device based on the current target distance and the maximum limiting speed, wherein the straight-line travelling speed component is positively correlated with the current target distance;
determining a turning speed component of the mobile device based on the current turning curvature and the maximum limiting speed, wherein the turning speed component is negatively correlated with the current turning curvature; and
based on a preset straight-line travelling speed weight and a preset turning speed weight, performing a weighted fusion processing on the straight-line travelling speed component and the turning speed component to obtain the target speed of the mobile device.

7. The method according to claim 6, wherein
the current target distance comprises a first distance perpendicular to the target path and a second distance parallel to the target path; and
the determining the straight-line travelling speed component of the mobile device based on the current target distance and the maximum limiting speed comprises:
determining a first speed component of the mobile device based on the first distance and the maximum limiting speed;
determining a second speed component of the mobile device based on the second distance and the maximum limiting speed; and
obtaining the straight-line travelling speed component based on the first speed component and the second speed component.

8. The method according to claim 1, wherein the controlling the mobile device to move at the target speed comprises:
controlling the mobile device to move at the target speed in response to the target speed satisfying a preset speed range.

9. (canceled)

10. A mobile device, comprising:
a processor; and
a memory storing computer instructions for causing the processor to perform acts comprising:
obtaining a cost map of a moving area and a target path of the mobile device moving in the moving area;
based on the cost map, determining a current target distance between the mobile device and an obstacle, and a current turning curvature of the mobile device in response to determining that the mobile device moving along the target path;
determining a target speed of the mobile device based on the current target distance, the current turning curvature, and a maximum limiting speed of the mobile device; and
controlling the mobile device to move at the target speed.

11. (canceled)

12. The mobile device according to claim 10, wherein the processor is further configured to perform acts comprising:
obtaining scene data of the moving area collected through one or more sensors of the mobile device;
performing localization on the mobile device and mapping based on the scene data to obtain a current position of the mobile device and an environment map; and
obtaining the cost map of the moving area based on obstacle information in the environment map, and determining the target path of the mobile device based on the cost map and the current position.

13. The mobile device according to claim 10, wherein the processor is further configured to perform acts comprising:
based on the cost map, determining obstacle data within a preset range in front of the mobile device;
based on the obstacle data, determining a first distance between the obstacle and the target path, and a second distance between the obstacle and a current position of the mobile device, wherein the first distance is perpendicular to the target path, and the second distance is parallel to the target path; and
obtaining the current target distance based on the first distance and the second distance.

14. The mobile device according to claim 10, wherein the processor is further configured to perform acts comprising:
based on the cost map, determining a first reference line segment and a second reference line segment within a preset range in front of the mobile device, wherein the first reference line segment and the second reference line segment are both perpendicular to the target path, and a preset distance is spaced between the first reference line segment and the second reference line segment; and
determining the current turning curvature of the mobile device based on an angle between the first reference line segment and the second reference line segment.

15. The mobile device according to claim 14, wherein the processor is further configured to perform acts comprising:
in response to the first reference line segment intersecting with the second reference line segment, determining intersection coordinates of the first reference line segment and the second reference line segment based on the cost map, determining the angle between the first reference line segment and the second reference line segment based on the intersection coordinates and the preset distance, and determining the angle as the current turning curvature; or
in response to the first reference line segment not intersecting with the second reference line segment, determining that the current turning curvature is zero.

16. The mobile device according to claim 10, wherein the processor is further configured to perform acts comprising:
determining a straight-line travelling speed component of the mobile device based on the current target distance and the maximum limiting speed, wherein the straight-line travelling speed component is positively correlated with the current target distance;
determining a turning speed component of the mobile device based on the current turning curvature and the maximum limiting speed, wherein the turning speed component is negatively correlated with the current turning curvature; and
based on a preset straight-line travelling speed weight and a preset turning speed weight, performing a weighted fusion processing on the straight-line travelling speed component and the turning speed component to obtain the target speed of the mobile device.

17. The mobile device according to claim 16, wherein the processor is further configured to perform acts comprising:
determining a first speed component of the mobile device based on a first distance of the current target distance and the maximum limiting speed, wherein the first distance is perpendicular to the target path;
determining a second speed component of the mobile device based on a second distance of the current target distance and the maximum limiting speed, wherein the second distance is parallel to the target path; and
obtaining the straight-line travelling speed component based on the first speed component and the second speed component.

18. The mobile device according to claim 10, wherein the processor is further configured to:
control the mobile device to move at the target speed in response to the target speed satisfying a preset speed range.

19. A non-transitory computer-readable storage medium storing computer instructions, wherein the computer instructions cause a computer to perform acts comprising:
obtaining a cost map of a moving area and a target path of the mobile device moving in the moving area;
based on the cost map, determining a current target distance between the mobile device and an obstacle, and a current turning curvature of the mobile device in response to determining that the mobile device moving along the target path;
determining a target speed of the mobile device based on the current target distance, the current turning curvature, and a maximum limiting speed of the mobile device; and
controlling the mobile device to move at the target speed.

20. The non-transitory computer-readable storage medium according to claim 19, wherein the computer is further configured to perform acts comprising:
obtaining scene data of the moving area collected through one or more sensors of the mobile device;
performing localization on the mobile device and mapping based on the scene data to obtain a current position of the mobile device and an environment map; and
obtaining the cost map of the moving area based on obstacle information in the environment map, and determining the target path of the mobile device based on the cost map and the current position.

21. The non-transitory computer-readable storage medium according to claim 19, wherein the computer is further configured to perform acts comprising:
based on the cost map, determining obstacle data within a preset range in front of the mobile device;
based on the obstacle data, determining a first distance between the obstacle and the target path, and a second distance between the obstacle and a current position of the mobile device, wherein the first distance is perpendicular to the target path, and the second distance is parallel to the target path; and
obtaining the current target distance based on the first distance and the second distance.

22. The non-transitory computer-readable storage medium according to claim 19, wherein the computer is further configured to perform acts comprising:
based on the cost map, determining a first reference line segment and a second reference line segment within a preset range in front of the mobile device, wherein the first reference line segment and the second reference line segment are both perpendicular to the target path, and a preset distance is spaced between the first reference line segment and the second reference line segment; and
determining the current turning curvature of the mobile device based on an angle between the first reference line segment and the second reference line segment.
